(19) United States
(12) Patent Application Publication
(10) Pub. No.: US 2008/0063871 A1
(43) Pub. Date: Mar. 13, 2008

(54) Adhesive film composition for semiconductor assembly, associated dicing die bonding film and semiconductor package

(76) Inventors: Ki Sung Jung, Gunpo-si (KR); Wan Jung Kim, Seoul (KR); Yong Woo Hong, Suwon-si (KR); Chul Jeong, Seoul (KR); Chang Bum Chung, Yongin-si (KR)

Correspondence Address: LEE & MORSE, P.C., 3141 FAIRVIEW PARK DRIVE, SUITE 500, FALLS CHURCH, VA, 22042, US

(21) Appl. No.: 11/898,143

(22) Filed: Sep. 10, 2007

(30) Foreign Application Priority Data
Sep. 11, 2006 (KR) 10-2006-0087397
Sep. 5, 2007 (KR) 10-2007-0090009

(51) Int. Cl. B32B 27/38; C08K 5/3492

(52) U.S. Cl. 428/414; 428/413; 524/100; 524/588

(57) ABSTRACT

An adhesive film composition, including an elastomer resin having one or more of a hydroxy group, a carboxyl group, or an epoxy group, a film-forming resin having a glass transition temperature of about −10° C. to about 200° C., an epoxy resin, a phenol-type curing agent, a curing catalyst, a pre-curable additive, a silane coupling agent, and a filler.

### BACKGROUND OF THE INVENTION

1. Field of the Invention

Embodiments relate to an adhesive film composition and, more particularly, to an adhesive film composition which may be employed to form an adhesive film for use in semiconductor assembly and packaging.

2. Description of the Related Art

Recently, there has been increasing interest in using adhesive films for semiconductor manufacturing, assembly and packaging. For example, an adhesive film may be employed as part of a dicing film, which may be used to fix a semiconductor wafer during a dicing process in a sequence of semiconductor chip manufacturing processes. A typical process of using an adhesive film for semiconductor assembly may include laminating the dicing film to a semiconductor wafer and then cutting the semiconductor wafer in a dicing process. A dicing process is a process of cutting a semiconductor wafer into individual semiconductor devices, i.e., chips. Following the dicing process, an expanding process, a pick-up process and die attaching process may be sequentially performed.

The application of adhesive films to semiconductor manufacturing may be extended by employing the adhesive film as part of a dicing die bonding film, which is an integrated film used for both dicing and die bonding, i.e., die attach. In such a process, however, a pick-up process may require that a die laminated with the adhesive layer be completely picked up, e.g., removed from a pressure sensitive adhesive (PSA) layer. Thus, the level of adhesion between the adhesive layer and the die may need to be high, in order to separate the die from the PSA layer. Further, the application of the adhesive film to a dicing die bonding film may demand greater reliability, e.g., increased tensile strength, of the adhesive film.

### SUMMARY OF THE INVENTION

Embodiments are therefore directed to an adhesive film composition for semiconductor assembly and associated dicing die bonding film, semiconductor package and method of use, which substantially overcome one or more of the problems due to the limitations and disadvantages of the related art.

It is therefore a feature of an embodiment of the present invention to provide an adhesive film composition which may be employed to form a dicing die bonding film exhibiting increased tensile strength, and a semiconductor package including the same.

It is therefore another feature of an embodiment of the present invention to provide an adhesive film composition which may be employed to form a dicing die bonding film exhibiting good adhesion to a semiconductor die and good separation from an adjacent adhesive layer, and a semiconductor package including the same.

At least one of the above and other features and advantages of the present invention may be realized by providing an adhesive film composition, including an elastomer resin having one or more of a hydroxy group, a carboxyl group, or an epoxy group, a film-forming resin having a glass transition temperature of about −10° C. to about 200° C., an epoxy resin, a phenol-type curing agent, a curing catalyst, a pre-curable additive, a silane coupling agent, and a filler.

The adhesive film composition may further include an organic solvent. The composition may include, based on the weight of the elastomer resin, about 10 to about 60 parts by weight of the film-forming resin, about 10 to about 60 parts by weight of the epoxy resin, about 5 to about 30 parts by weight of the phenol-type curing agent, about 0.01 to about 5 parts by weight of the curing catalyst, about 0.01 to about 30 parts by weight of the pre-curable additive, about 0.01 to about 10 parts by weight of the silane coupling agent, and about 0.1 to about 60 parts by weight of the filler.

The elastomer resin may have a weight average molecular weight of about 500 to about 5,000,000. The film-forming resin may include one or more of a phenol resin or a phenoxy resin, may have one or more of a hydroxy group, an epoxy group, a phenoxy group or an alkyl group, and may have a weight average molecular weight of about 200 to about 300,000. The epoxy resin may include one or more of a bisphenol epoxy resin, a phenol novolac epoxy resin, an ortho-cresol novolac epoxy resin, a multi-functional epoxy resin, an amine epoxy resin, a heterocyclic epoxy resin, a substituted epoxy resin, or a naphthol epoxy resin. The phenol-type curing agent may include one or more of a phenol novolac resin, a xylok resin, a bisphenol A novolac resin, or a cresol novolac resin. The curing catalyst may include one or more of a melamine-type catalyst, an imidazole-type catalyst, or a triphenylphosphine-type catalyst.

The pre-curable additive may include an isocyanate. The pre curable additive may include one or more of the following isocyanates: 4,4′-diphenylmethane diisocyanate, trilene diisocyanate, xylene diisocyanate, 4,4′-diphenylether diisocyanate, 4,4′-[2,2-bis(4-phenoxyphenylpropane)]diisocyanate, hexamethylene diisocyanate, 4,4′-dicyclohexylmethane diisocyanate, 2,4′-dicyclohexylmethane diisocyanate, 2,2,4-trimethyl-hexamethylene diisocyanate, isophorone diisocyanate, lysine diisocyanate, cyclohexylmethane diisocyanate, 1,6-hexamethylene diisocyanate, or a reaction product of diisocyanate or triisocyanate with polyol.

The pre-curable additive may include an amine. The pre curable additive may include one or more of the following amines: diethylene triamine, triethylene tetramine, diethylaminopropylamine, menthane diamine, N-aminoethyl piperazine, m-xylene diamine, or isophorone diamine.

The silane coupling agent may include one or more of an amine-containing silane, an epoxy-containing silane, or a mercapto-containing silane. The filler may be a spherical or amorphous inorganic filler containing metal or nonmetal components, and may have a size of about 5 nm to about 20 μm.

The adhesive film composition may further include an ion scavenger, and the ion scavenger may include one or more of a triazine-thiol compound, a zirconium compound, an antimony-bismuth compound, or a magnesium-aluminum compound. The composition may include, based on the weight of the elastomer resin, about 0.01 to about 5 parts by weight of the ion scavenger.

At least one of the above and other features and advantages of the present invention may also be realized by providing a dicing die bonding film, including a base film, a first adhesive layer (PSA), and an adhesive film, the first adhesive layer (PSA) being disposed between the base film and the adhesive film. The adhesive film may include a composition having: an elastomer resin having one or more of a hydroxy group, a carboxyl group, or an epoxy group, a film-forming resin having a glass transition temperature of about −10° C. to about 200° C., an epoxy resin, a phenol-type curing agent, a curing catalyst, a pre-curable additive, a silane coupling agent, and a filler.

At least one of the above and other features and advantages of the present invention may also be realized by providing a semiconductor package, including a semiconductor device, an adhesive film, and a substrate, the adhesive film being disposed between the semiconductor device and the substrate. The adhesive film may include a composition having: an elastomer resin having one or more of a hydroxy group, a carboxyl group, or an epoxy group, a film-forming resin having a glass transition temperature of about −10° C. to about 200° C., an epoxy resin, a phenol-type curing agent, a curing catalyst, a pre-curable additive, a silane coupling agent, and a filler.

At least one of the above and other features and advantages of the present invention may also be realized by providing a method of packaging a semiconductor device, including attaching a dicing die bonding film to a semiconductor wafer, separating the semiconductor device by dicing the semiconductor wafer while the semiconductor wafer is attached to the dicing die bonding film, removing the semiconductor device from the dicing die bonding film by separating an adhesive film from the dicing die bonding film, such that the adhesive film remains attached to the semiconductor device, and attaching the semiconductor device to a substrate, the adhesive film being disposed between the semiconductor device and the substrate. The adhesive film may include a composition having: an elastomer resin having one or more of a hydroxy group, a carboxyl group, or an epoxy group, a film-forming resin having a glass transition temperature of about −10° C. to about 200° C., an epoxy resin, a phenol-type curing agent, a curing catalyst, a pre-curable additive, a silane coupling agent, and a filler.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIGS. 1A and 1B illustrate stages in a method of packaging a semiconductor device according to an embodiment; and

FIG. 2 illustrates a schematic view of a technique for measuring die shear strength.

### DETAILED DESCRIPTION OF THE INVENTION

Korean Patent Application No. 10-2006-0087397, filed on Sep. 11, 2006, in the Korean Intellectual Property Office, and Korean Patent Application No. 10-2007-0090009, filed on Sep. 5, 2007 in the Korean Intellectual Property Office, both of which are entitled: “Adhesive Film Composition for Semiconductor Assembly Comprising Pre-Curable Additives,” are incorporated by reference herein in their entirety.

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of layers and regions may be exaggerated for clarity of illustration. It will also be understood that when a layer or element is referred to as being “on” another layer or substrate, it can be directly on the other layer or substrate, or intervening layers may also be present. Further, it will be understood that when a layer is referred to as being “under” another layer, it can be directly under, and one or more intervening layers may also be present. In addition, it will also be understood that when a layer is referred to as being “between” two layers, it can be the only layer between the two layers, or one or more intervening layers may also be present. Like reference numerals refer to like elements throughout.

As used herein, the expressions “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C” and “A, B, and/or C” includes the following meanings: A alone; B alone; C alone; both A and B together; both A and C together; both B and C together; and all three of A, B, and C together. Further, these expressions are open-ended, unless expressly designated to the contrary by their combination with the term “consisting of.” For example, the expression “at least one of A, B, and C” may also include an n^{th} member, where n is greater than 3, whereas the expression “at least one selected from the group consisting of A, B, and C” does not.

As used herein, the expression “or” is not an “exclusive or” unless it is used in conjunction with the term “either.” For example, the expression “A, B, or C” includes A alone; B alone; C alone; both A and B together; both A and C together; both B and C together; and all three of A, B and, C together, whereas the expression “either A, B, or C” means one of A alone, B alone, and C alone, and does not mean any of both A and B together; both A and C together; both B and C together; and all three of A, B and C together.

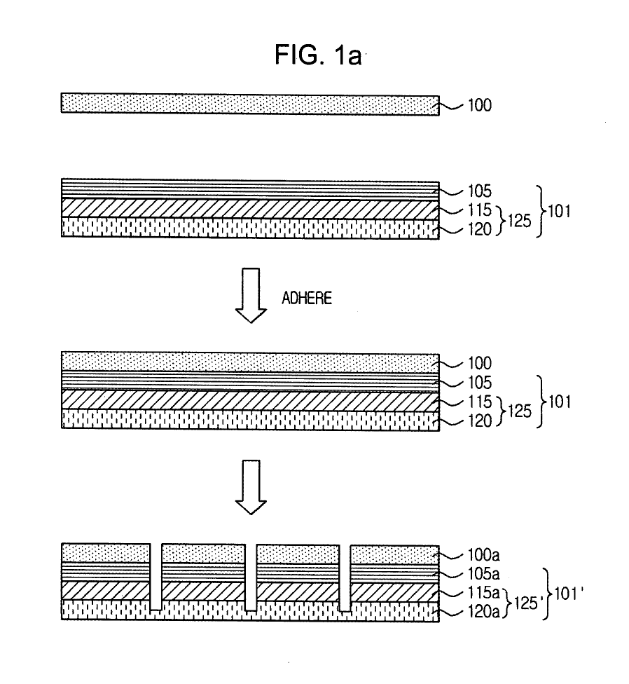

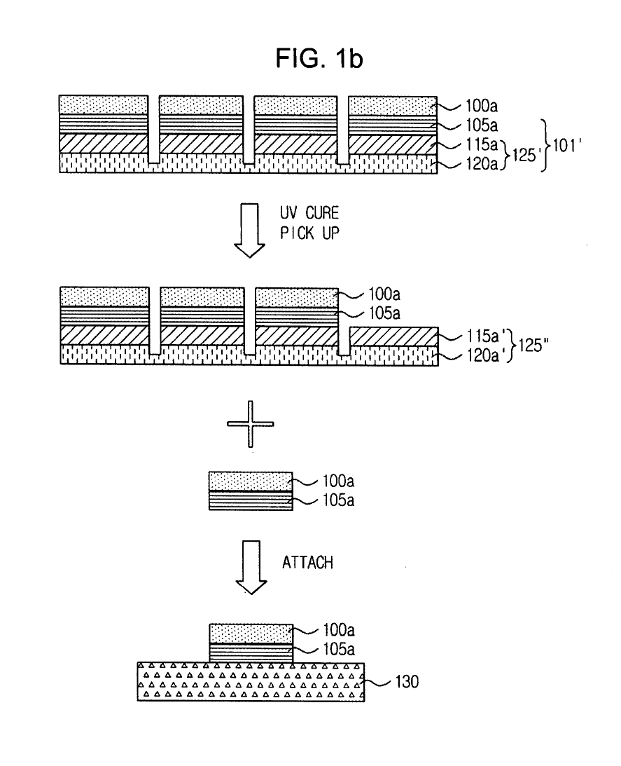

FIGS. 1A and 1B illustrate stages in an example method of packaging a semiconductor device according to an embodiment, wherein a semiconductor wafer is diced and an individual semiconductor device, i.e., die, is attached to a substrate using a dicing die bonding film.

Referring to FIGS. 1A and 1B, a semiconductor wafer 100 may have a plurality of devices fabricated thereon, e.g., memory devices, microprocessors, etc. In order to package the devices, it may be desirable to separate the semiconductor wafer 100 along scribe lines so as to form a plurality of dies 100a. This dicing process may involve laminating the entire, un-diced wafer 100 with a dicing die bonding film 101 that includes a dicing film 125 and an intermediate adhesive layer 105. The adhesive layer 105 of the dicing die bonding film 101 may be formed using an adhesive film composition according to an embodiment.

The dicing film 125 may include a PSA layer 115 and a base film 120. The PSA layer 115 may be, e.g., a non-curing film or a UV-curing film. The base film 120 may be, e.g., a vinylchloride film such as PVC or a polyolefin. In an implementation, the dicing film 125 may be fabricated by laminating the PSA layer 115 with the base film 120.

The dicing die bonding film 101 may be attached to the semiconductor wafer 100 at the adhesive film 105, and the PSA layer 115 may face and be attached to the adhesive layer 105.

As described above, a wafer assembly may be formed having the un-diced wafer 100 bonded to the dicing die bonding film 101 that includes the adhesive layer 105 according to an embodiment.

A dicing process may then be performed to separate the wafer 100 into a plurality of dies 100a. The dicing process may also separate the adhesive layer 105 into parts 105a corresponding to the individual dies 100a, as indicated by the separated adhesive layer 105a of the post-dicing dicing die bonding film 101′. Similarly, the dicing film 125 may be partially separated to form dicing film 125′ having the PSA layer 115 separated into parts 115a and the base film 120 partially separated into parts 120a. Throughout the dicing process, the wafer 100/dies 100a may remain adhered to the dicing die bonding film 101/101′.

Referring to FIG. 1B, an individual die 100a may be removed from the dicing die bonding film 101′. This process may be enabled by exposing the assembly to ultraviolet (UV) light, which may cure the PSA layer 115a to yield a cured PSA layer 115a′ having a reduced level of adhesion. In particular, the cured PSA layer 115a′ may have a significantly lower adhesion to the diced adhesive layer 105a, such that, during pick up of the individual die 100a, the diced adhesive layer 105a remains adhered to the individual die 100a and releases from the cured PSA layer 115a′. Thus, the pick up process may remove the individual die 100a and its associated diced adhesive layer 105a, which may then be mounted to a substrate 130, with the diced adhesive layer 105a facing and in contact with the substrate 130, such that the individual die 100a is attached to the substrate 130. Further processes, e.g., wiring, encapsulation, etc., may also be performed.

The adhesive layer 105 may be formed using an adhesive film composition according to an embodiment, details of which will now be described.

According to an embodiment, the adhesive film composition may include an elastomer resin, a film-forming resin, an epoxy resin, a phenol-type curing agent, a curing catalyst, a pre-curable additive, a silane coupling agent, a filler, and an organic solvent.

The elastomer resin may be a film-forming rubber. The elastomer resin may have one or more of a hydroxy group, a carboxyl group, or an epoxy group. The elastomer resin may have a weight average molecular weight of about 500 to about 5,000,000. The elastomer resin may include, e.g., one or more of an acrylonitrile elastomer, a butadiene elastomer, a styrene elastomer, an acryl elastomer, an isoprene elastomer, an ethylene elastomer, a propylene elastomer, a polyurethane elastomer, or a silicone elastomer. In an implementation, the adhesive film composition may include about 5 to about 75 parts by weight of the elastomer resin, based on the total weight of the adhesive film composition.

The film-forming resin may promote the formation of an adhesive film. The film forming resin may have a glass transition temperature of, e.g., about −10° C. to about 200° C. The film-forming resin may include one or more of, e.g., a phenol resin or a phenoxy resin. The film-forming resin may have one or more of a hydroxy group, an epoxy group, a phenoxy group or an alkyl group. The film-forming resin may have a weight average molecular weight of about 200 to about 300,000. The adhesive film composition may include about 10 to about 60 parts by weight of the film-forming resin, based on the weight of the elastomer resin, i.e., for every 100 weight parts of elastomer resin, the adhesive film composition may include about 10 to about 60 parts by weight of the film-forming resin.

The film-forming resin may include, e.g., backbones of hydroquinone, 2-bromohydroquinone, resorcinol, catechol, bisphenol A, bisphenol F, bisphenol AD, bisphenol S, 4,4′-dihydroxybiphenyl, bis(4-hydroxyphenyl)ether, a phenol group, a cresol group, a cresol novolac group, and/or a fluorene group, in which the backbones thereof may be substituted with an alkyl group, an aryl group, a methylol group, an allyl group, a cyclic aliphatic group, halogen, and/or a nitro group. In an implementation, the central carbon atom of the bisphenol backbone may be substituted with a straight-chained alkyl group, a branched alkyl group, an allyl group, a substituted allyl group, a cyclic aliphatic group, or an alkoxy carbonyl group.

The epoxy resin may exhibit curability and adhesion. Depending on the shape of the adhesive film, it may be desirable that the epoxy resin be a solid or solid-like epoxy resin having one or more functional groups. The epoxy resin may include one or more of, e.g., a bisphenol epoxy resin, a phenol novolac epoxy resin, an ortho-cresol novolac epoxy resin, a multi-functional epoxy resin, an amine epoxy resin, a heterocyclic epoxy resin, a substituted epoxy resin, or a naphthol epoxy resin, each of which may be used alone or in combination with one or more other epoxy resins. The adhesive film composition may include about 10 to about 60 parts by weight of the epoxy resin, based on the weight of the elastomer resin.

Commercially available examples of the bisphenol epoxy resin include EPICLON® 830-S, EPICLON® EXA-830CRP, EPICLON®EXA 850-S, EPICLON® EXA-850CRP and EPICLON® EXA-835LV (EPICLON® is manufactured by Dainippon Ink & Chemicals, Inc. (DIC Corp.) (Japan)); EPIKOTE™ 807, EPIKOTE™ 815, EPIKOTE™ 825, EPIKOTE™ 827, EPIKOTE™ 828, EPIKOTE™ 834, EPIKOTE™ 1001, EPIKOTE™ 1004, EPIKOTE™ 1007 and EPIKOTE™ 1009 (EPIKOTE™ is manufactured by Hexion Specialty Chemicals, Inc. (U.S.A.) (formerly Yuka-Shell Epoxy Co., Ltd., and Resolution Performance Products, LLC)); D.E.R.™ 330, D.E.R.™ 301, and D.E.R.™ 361, (D.E.R.™ is manufactured by Dow Chemical Co. (U.S.A.)); and YD-128 and YDF-170 (manufactured by Kukdo Chemical Co., Ltd. (Korea)). Commercially available examples of the phenol novolac epoxy resin include EPIKOTE™ 152 and EPIKOTE™ 154; EPPN-201 (manufactured by Nippon Kayaku Co., Ltd. (Japan)); and D.E.N.™ 438 (manufactured by Dow Chemical Co. (U.S.A.)). Commercially available examples of the ortho-cresol novolac epoxy resin include YDCN-500-1P, YDCN-500-2P, YDCN-500-4P, YDCN-500-5P, YDCN-500-7P, YDCN-500-8P, YDCN-500-10P, YDCN-500-80P and YDCN-500-90P (manufactured by Kukdo Chemical Co., Ltd. (Korea)); EOCN-102S, EOCN-103S, EOCN-104S, EOCN-1012, EOCN-1025 and EOCN-1027 (manufactured by Nippon Kayaku Co., Ltd. (Japan)); YDCN-701, YDCN-702, YDCN-703 and YDCN-704 (manufactured by Tohto Kasei Co., Ltd. (Japan)); and EPICLON® N-665-EXP. Commercially available examples of the multi-functional epoxy resin include EPON™ 1031S (manufactured by Hexion Specialty Chemicals, Inc. (U.S.A.) (formerly Yuka-Shell Epoxy Co., Ltd., and Resolution Performance Products, LLC)); Araldite® 0163 (manufactured by Ciba Specialty Chemicals (Switzerland)); and DENACOL® EX-611, DENACOL® EX-614, DENACOL® EX-614B, DENACOL® EX-622, DENACOL® EX-512, DENACOL® EX-521, DENACOL® EX-421, DENACOL® EX-411 and DENACOL® EX-321 (DENACOL® is manufactured by Nagase ChemteX Corp. (formerly Nagase Chemicals Ltd.) (Japan)). Commercially available examples of the amine epoxy resin include EPIKOTE™ 604; YH-434 (manufactured by Tohto Kasei Co., Ltd. (Japan)); TETRAD® X® and TETRAD® C (TETRAD® is manufactured by Mitsubishi Gas Chemical Co., Inc. (Japan)); and ELM-120 (manufactured by Sumitomo Chemical Co., Ltd. (Japan)). A commercially available example of the heterocyclic epoxy resin is Araldite® PT-810. Commercially available examples of the substituted epoxy resin include ERL-4234, ERL-4299, ERL-4221 and ERL-4206 (manufactured by Union Carbide Corp.). Commercially available examples of the naphthol epoxy resin include EPICLON® HP-4032, EPICLON® HP-4032D, EPICLON® HP-4700 and EPICLON® 4701.

The phenol-type curing agent may include one or more of, e.g., a bisphenol A resin, a bisphenol F resin, a bisphenol S resin, a phenol novolac resin, a xylok resin, a bisphenol A novolac resin, a cresol novolac resin, or a multi-functional phenol resin (such as MEH-7500 manufactured by Meiwa Plastic Industries, Ltd. (Japan)), each of which may be used alone or in combination with one or more other phenol-type curing agents. The phenol-type curing agent may be a compound having two or more phenolic hydroxy groups in one molecule and having a high electrolytic corrosion resistance when exposed to moisture. The adhesive film composition may include about 5 to about 30 parts by weight of the phenol-type curing agent, based on the weight of the elastomer resin.

Commercially available examples of the phenol-type curing agent include KPH-F3065 and KPH-F3065 (manufactured by Kolon Chemical Co., Ltd (Korea)); and H-1, H-4, HF-1M, HF-3M, HF-4M and HF-45 (manufactured by Meiwa Plastic Industries, Ltd. (Japan)). Commercially available examples of the phenol-type curing agent (para-xylene type) include MEH-78004S, MEH-7800SS, MEH-7800S, MEH-7800M, MEH-7800H, MEH-7800HH and MEH-78003H (manufactured by Meiwa Plastic Industries, Ltd. (Japan)). Commercially available examples of the phenol-type curing agent (biphenyl type) include MEH-7851SS, MEH-7851S, MEH7851M, MEH-7851H, MEH-78513H and MEH-78514H (manufactured by Meiwa Plastic Industries, Ltd. (Japan)). Commercially available examples of the phenol-type curing agent (triphenylmethyl type) include MEH-7500, MEH-75003S, MEH-7500SS, MEH-7500S and MEH-7500H (manufactured by Meiwa Plastic Industries, Ltd. (Japan)).

The curing catalyst may function to reduce the curing time, so as to completely cure an epoxy resin during a semiconductor process. The curing catalyst may include one or more of, e.g., a melamine-type catalyst, an imidazole-type catalyst, or a triphenylphosphine-type catalyst, each of which may be used alone or in combination with one or more other curing catalysts. The adhesive film composition may include about 0.01 to about 5 parts by weight of the curing catalyst, based on the weight of the elastomer resin.

Commercially available examples of the imidazole-type curing catalyst include Ajicure® PN-23 and Ajicure® PN-40 (Ajicure® is manufactured by Ajinomoto Co., Inc. (Japan)); and 2P4MZ, 2MA-OK, 2MAOK-PW and 2P4 MHZ (manufactured by Shikoku Chemicals Corp. (Japan)). Commercially available examples of the triphenylphosphine-type curing agent include TPP-K and TPP-MK (manufactured by Hokko Chemical Industry Co., Ltd. (Japan)).

The pre-curable additive may be pre-cured at the time of fabricating the adhesive film 125. The pre-curable additive may increase the tensile strength and hardness of the adhesive film 125, and may decrease elongation of the film through pre-curing the adhesive film composition during a film manufacturing process. The pre-curable additive may include, e.g., an isocyanate resin. The isocyanate resin may have one or more functional groups, which may be pre-cured so as to increase the hardness and decrease the elongation of the adhesive film 125. The pre-curable additive may include, e.g., an amine resin, which may cure faster than an epoxy resin and a phenol resin. The adhesive film composition may include about 0.01 to about 30 parts by weight of the pre-curable additive, based on the weight of the elastomer resin. Without intending to be bound by theory, a hydroxy group included in the adhesive film composition may react with the isocyanate-type precurable additive or the amine-type of pre-curable additive, such that the adhesive film 125 may be fabricated having excellent material properties.

The isocyanate-type pre-curable additive may include, e.g., aromatic isocyanates such as 4,4′-diphenylmethane diisocyanate, trilene diisocyanate, xylene diisocyanate, 4,4′-diphenylether diisocyanate or 4,4′-[2,2-bis(4-phenoxyphenylpropane)]diisocyanate, non-aromatic isocyanates such as hexamethylene diisocyanate, 4,4′-dicyclohexylmethane diisocyanate, 2,4′-dicyclohexylmethane diisocyanate, 2,2,4-trimethyl-hexamethylene diisocyanate, isophorone diisocyanate or lysine diisocyanate, and other non-aromatic isocyanates such as cyclohexylmethane diisocyanate or 1,6-hexamethylene diisocyanate. Further, modified isocyanate compounds prepared by chemically reacting diisocyanate or triisocyanate with polyol may be used as the pre-curable additive. The pre-curable additives may be used alone or in combination with one or more other pre-curable additives.

Commercially available examples of modified isocyanate compounds, prepared as described above by chemically reacting diisocyanate or triisocyanate with polyol, include Coronate® HX, Coronate® HK, Coronate® HX-TPX, Coronate® HXR, Coronate® HX-LV, Coronate® LVA-325, Coronate® LVA-410, Coronate® L (in which toluene diisocyanate is chemically modified with trimethylene propionate), Coronate® L/55E (which is a toluene diisocyanate compound), Coronate® AP stable, Coronate® 2030 (which is a three functional modifier of toluene diisocyanate), Coronate® 2503 (which is modified 4,4-diphenylmethane diisocyanate), Coronate® 2515 (which is a 1,6-hexamethylene diisocyanate compound), Coronate® 2507, Coronate® 2513, Coronate® 2517, Coronate® 2527, Coronate® 2529, Coronate® BI-301 (which is blocked with methylethylketoneoxime) and Coronate® BI-311 (which is blocked with caprolactam) (Coronate® is manufactured by Nippon Polyurethane Industry Co., Ltd. (Japan)).

The amine type pre-curable additive may include, e.g., diethylene triamine, triethylene tetramine, diethylaminopropylamine, menthane diamine, N-aminoethyl piperazine, m-xylene diamine or isophorone diamine, each of which may be used alone or in combination with one or more other pre-curable additives.

The silane coupling agent may promote adhesion between inorganic materials, such as silica, and organic materials though organic-inorganic hybrid chemical bonds. The adhesive film composition may include about 0.01 to about 10 parts by weight of the silane coupling agent, based on the weight of the elastomer resin.

The silane coupling agent may include epoxy-containing compounds such as 2-(3,4-epoxycyclohexyl)-ethyltrimethoxy silane, 3-glycidoxytrimethoxy silane and 3-glycidoxypropyltriethoxy silane. The silane coupling agent may also include amine-containing compounds such as N-(2-aminoethyl)-3-aminopropylmethyldimethoxy silane, N-(2-aminoethyl)-3-aminopropyltrimethoxy silane, N-(2-aminoethyl)-3-aminopropyltriethoxy silane, 3-aminopropyltrimethoxy silane, 3-aminopropyltriethoxy silane, 3-triethoxy-N-(1,3-dimethylbutylidene)propylamine and N-phenyl-3-aminopropyltrimethoxy silane. The silane coupling agent may also include mercapto compounds such as 3-mercaptopropylmethyldimethoxy silane or 3-mercaptopropyltriethoxy silane. The silane coupling agent may also include isocyanate compounds such as 3-isocyanatepropyltriethoxy silane. The silane coupling agents may be used alone or in combination with one or more other silane coupling agents.

The filler may include, e.g., an inorganic filler or an organic filler. The inorganic filler may include metal components, such as gold, silver, copper or nickel powder, and nonmetal components, such as alumina and other oxides of aluminum, aluminum hydroxide, magnesium hydroxide, calcium carbonate, magnesium carbonate, calcium silicate, magnesium silicate, calcium oxide, magnesium oxide, aluminum nitride, silica, boron nitride, titanium dioxide, glass, iron oxide or ceramic. The organic filler may include, e.g., carbon, rubber or polymer. The shape and size of the filler may be suitably varied. In an implementation, spherical silica or amorphous silica may be used as the inorganic filler and may have a size of about 5 nm to about 20 μm. The adhesive film composition may include about 0.1 to about 60 parts by weight of the filler, based on the weight of the elastomer resin.

The organic solvent may be used to decrease the viscosity of the adhesive film composition and facilitate fabrication of the adhesive film 125. The organic solvent may include, e.g., toluene, xylene, propylene glycol monomethyl ether acetate, benzene, acetone, methylethylketone, tetrahydrofuran, dimethylformamide or cyclohexanone.

The organic solvent may be included in the adhesive film composition as the balance, excluding residual components of the composition. The adhesive film composition may include about 100 to about 1,000 parts by weight of the organic solvent, based on the weight of the elastomer resin, i.e., based on 100 parts of the elastomer resin.

The adhesive film composition may further include an ion scavenger, which may adsorb ionic impurities and thus reduce or eliminate ions that may degrade the electrical insulation properties of the adhesive film 125 if the adhesive film 125 is exposed to moisture. The ion scavenger may include, e.g., an inorganic adsorbent such as a triazine-thiol compound, a zirconium compound, an antimony-bismuth compound, or a magnesium-aluminum compound. The adhesive film composition may include about 0.01 to about 5 parts by weight of the ion scavenger, based on the weight of the elastomer resin.

Particular implementations of embodiments will now be described in the following Examples. It will be appreciated that these Examples are merely illustrative and are not to be construed as limiting the present invention thereto.

### EXAMPLES

The listed components were put into a IL cylindrical flask provided with a high-speed stirring rod, and were rapidly dispersed at a speed of 4000 rpm for 20 minutes, thereby preparing a composition. Subsequently, the composition was completely pulverized using a ball mill. The composition was pulverized twice or more. Next, the pulverized composition was filtered using a 50 μm capsule filter, and was then applied to a thickness of 20 μm, thereby fabricating an adhesive film. The adhesive film was dried at a temperature of 90° C. for 20 minutes, and was then left at a temperature of 40° C. for 3 days. In the following Examples, the ratio of epoxy/hardener equivalents may be about 1.0.

### Example 1

### Fabrication of an Adhesive Film

(a) 400 g of a carboxyl group- and hydroxy group-containing elastomer resin (KLS-1038, manufactured by Fujikura Kasei Co., Ltd. (Japan)),

(b) 60 g of a bisphenol A- and bisphenol F-containing film-forming resin (E4275, manufactured by Japan Epoxy Resins Co., Ltd. (Japan)),

(c) 60 g of a cresol novolac epoxy resin (YDCN-500-90P),

(d) 33 g of a phenol novolac curing agent (HF-1M),

(e) 0.6 g of an imidazole curing catalyst (2P4MZ),

(f) 7 g of a pre-curable additive containing modified toluene diisocyanate (Coronate® LS),

(g) 0.5 g of a mercapto-silane coupling agent (KBM-803, manufactured by Shin-Etsu Chemical Co., Ltd. (Japan)) and 0.5 g of an epoxy silane coupling agent (KBM-403, manufactured by Shin-Etsu Chemical Co., Ltd. (Japan)), and

(h) 20 g of an amorphous silica filler (AEROSIL® OX 50, manufactured by Degussa GmbH (Germany)).

### Example 2

### Fabrication of an Adhesive Film

(a) 400 g of a carboxyl group- and hydroxy group-containing elastomer resin (KLS-1046DR, manufactured by Fujikura Kasei Co., Ltd. (Japan)),

(b) 60 g of a carboxyl group- and hydroxy group-containing film-forming resin (WS-023, manufactured by Nagase ChemteX Corp. (formerly Nagase Chemicals Ltd.) (Japan)),

(c) 60 g of a cresol novolac epoxy resin (YDCN-500-4P),

(d) 40 g of a xylok curing agent (MEH-7800SS),

(e) 0.1 g of an imidazole curing catalyst (2P4MZ),

(f) 3 g of a pre-curable additive containing modified alkylisocyanate trimethylolpropane (Coronate® L-45),

(g) 1 g of an epoxy additive, which is a reaction product of epichlorohydrin and methyloxylenediamine and can be pre-cured with carboxyl groups of elastomer (E-5XM, manufactured by Soken Chemical & Engineering Co., Ltd. (Japan)),

(h) 0.5 g of a mercapto-silane coupling agent (KBM-803) and 0.5 g of a epoxy silane coupling agent (KBM-403), and

(i) 20 g of an amorphous silica filler (AEROSIL® OX 50).

### Example 3

### Fabrication of an Adhesive Film

(a) 400 g of a carboxyl group and hydroxy group containing elastomer resin (SG-708-6, manufactured by Nagase ChemteX Corp. (formerly Nagase Chemicals Ltd.) (Japan)),

(b) 60 g of a carboxyl group- and hydroxy group-containing elastomer resin (KLS-1036DR, manufactured by Fujikura Kasei Co., Ltd. (Japan)),

(c) 60 g of a cresol novolac epoxy resin (YDCN-500-1P),

(d) 40 g of a xylok curing agent (MEH-78004S, manufactured by Meiwa Plastic Industries, Ltd. (Japan)),

(e) 0.1 g of an imidazole curing catalyst (2P4MZ),

(f) 3 g of dicyclopentadienyl bisphenol cyanate ester, which is an isocyanate pre-curable additive having aromatic and non-aromatic cyclo groups (XU-717187, manufactured by Dow Chemical Co. (U.S.A.)),

(g) 1 g of an epoxy additive, which is a reaction product of epichlorohydrin and methyloxylenediamine and can be pre-cured with carboxyl groups of elastomer (E-5XM),

(h) 0.5 g of a mercapto silane coupling agent (KBM-803) and 0.5 g of an epoxy silane coupling agent (KBM-403), and

(i) 20 g of an amorphous silica filler (AEROSIL® OX 50).

### Example 4

### Fabrication of an Adhesive Film

(a) 300 g of an epoxy group-containing elastomer resin (SG-80H, manufactured by Nagase ChemteX Corp. (formerly Nagase Chemicals Ltd.) (Japan)),

(b) 100 g of a bisphenol A- and bisphenol F-containing film-forming resin (E4275),

(c) 80 g of a cresol novolac epoxy resin (YDCN-500-4P) and 10 g of a naphthol epoxy resin (EPICLON® HP-4032D),

(d) 36 g of a multi-functional type of curing agent (MEH-75003S),

(e) 0.6 g of an imidazole-type curing catalyst (2MA-OK),

(f) 2 g of an amine-type pre-curable additive (JEFFAMINE® D-230, manufactured by Huntsman International LLC (U.S.A.)),

(g) 0.5 g of a mercapto-silane coupling agent (KBM-803) and 0.5 g of an epoxy silane coupling agent (KBM-403), and

(h) 20 g of an amorphous silica filler (AEROSIL® R-972, manufactured by Degussa GmbH (Germany)).

### Example 5

### Fabrication of an Adhesive Film

(a) 100 g of a carboxyl group- and hydroxy group-containing acryl elastomer resin (SG-708-6) and 300 g of an epoxy group containing acryl elastomer (SG-P3TEA, manufactured by Nagase ChemteX Corp. (formerly Nagase Chemicals Ltd.) (Japan)),

(b) 60 g of a bisphenol A- and bisphenol F-containing film-forming resin (E4275),

(c) 80 g of a cresol novolac epoxy resin (YDCN-500-1P) and 10 g of a naphthol epoxy resin (EPICLON® HP-4032D),

(d) 65 g of a xylok curing agent (MEH-78004S),

(e) 0.6 g of an imidazole curing catalyst (2P4 MHZ),

(f) 3 g of an alkylamine pre-curable additive (TETA, manufactured by Kukdo Chemical Co., Ltd. (Korea)),

(g) 0.5 g of a mercapto-silane coupling agent (KBM-803) and 0.5 g of an epoxy silane coupling agent (KBM-403), and

(h) 20 g of an amorphous silica filler (AEROSIL® R-972).

### Example 6

### Fabrication of an Adhesive Film

(a) 100 g of a epoxy group-containing acryl elastomer resin (KLS-1045DR, manufactured by Fujikura Kasei Co., Ltd. (Japan)) and 300 g of an epoxy group-containing acryl elastomer (SG-P3TEA),

(b) 60 g of a bisphenol A- and bisphenol F-containing film-forming resin (E4275),

(c) 80 g of a cresol novolac epoxy resin (YDCN-500-1P), and 10 g of a naphthol epoxy resin (EPICLON® HP-4032D),

(d) 65 g of a xylok curing agent (MEH-78004S),

(e) 0.6 g of an imidazole curing catalyst (2P4 MHZ),

(f) 3 g of an alkylamine pre-curable additive (TETA),

(g) 0.5 g of a mercapto-silane coupling agent (KBM-803) and 0.5 g of a epoxy silane coupling agent (KBM-403), and

(h) 20 g of an amorphous silica filler (AEROSIL® R-972).

### Comparative Examples

In the Comparative Examples, the adhesive film was fabricated as in Examples 1 to 6, except that pre-curable additives were not included.

### Comparative Example 1

### Fabrication of an Adhesive Film (1)

(a) 400 g of a carboxyl group- and hydroxy group-containing elastomer resin (KLS-1038),

(b) 60 g of a bisphenol A- and bisphenol F-containing film-forming resin (E4275),

(c) 60 g of a cresol novolac epoxy resin (YDCN-500-90P),

(d) 33 g of a phenol novolac curing agent (HF-1M),

(e) 0.6 g of an imidazole curing catalyst (2P4MZ),

(f) 0.5 g of a mercapto-silane coupling agent (KBM-803) and 0.5 g of a epoxy silane coupling agent (KBM-403), and

(g) 20 g of an amorphous silica filler (AEROSIL® OX 50).

### Comparative Example 2

### Fabrication of an Adhesive Film

(a) 400 g of a carboxyl group and hydroxy group containing elastomer resin (KLS-1046DR),

(b) 60 g of a carboxyl group- and hydroxy group-containing film-forming resin (WS-023),

(c) 60 g of a cresol novolac epoxy resin (YDCN-500-4P),

(d) 40 g of a xylok curing agent (MEH-7800SS),

(e) 0.1 g of an imidazole curing catalyst (2P4MZ),

(f) 1 g of an epoxy additive, which is a reaction product of epichlorohydrin and methyloxylenediamine and can be pre-cured with carboxyl groups of elastomer (E-5XM),

(g) 0.5 g of a mercapto-silane coupling agent (KBM-803) and 0.5 g of a epoxy silane coupling agent (KBM-403), and

(h) 20 g of an amorphous silica filler (AEROSIL® OX-50).

### Comparative Example 3

### Fabrication of an Adhesive Film

(a) 400 g of a carboxyl group and hydroxy group containing elastomer resin (SG-708-6),

(b) 60 g of a carboxyl group and hydroxy group containing elastomer resin (KLS-1036DR),

(c) 60 g of a cresol novolac epoxy resin (YDCN-500-1P),

(d) 40 g of a xylock curing agent (MEH-78004S),

(e) 0.1 g of an imidazole curing catalyst (2P4MZ),

(g) 0.5 g of a mercapto silane coupling agent (KBM-803) and 0.5 g of a epoxy silane coupling agent (KBM-403), and

(h) 20 g of an amorphous silica filler (AEROSIL® OX-50).

### Comparative Example 4

### Fabrication of an Adhesive Film

(a) 300 g of a epoxy group containing elastomer resin (SG-80H),

(b) 100 g of a bisphenol A and bisphenol F containing film forming resin (E4275),

(c) 80 g of a cresol novolac epoxy resin (YDCN-500-4P) and 10 g of a naphthol epoxy resin (EPICLON® HP-4032D),

(d) 36 g of a multi-functional type of phenol curing agent (MEH-7500-3S),

(e) 0.6 g of an imidazole curing catalyst (2MA-OK),

(f) 0.5 g of a mercapto-silane coupling agent (KBM-803) and 0.5 g of a epoxy silane coupling agent (KBM-403), and

(g) 20 g of an amorphous silica filler (AEROSIL® R-972).

### Comparative Example 5

### Fabrication of an Adhesive Film

(a) 100 g of a carboxyl group- and hydroxy group-containing acryl elastomer resin (SG-708-6) and 300 g of an epoxy group containing acryl elastomer (SG-P3TEA),

(b) 60 g of a bisphenol A- and bisphenol F-containing film-forming resin (E4275),

(c) 80 g of a cresol novolac epoxy resin (YDCN-500-1P) and 10 g of a naphthol epoxy resin (EPICLON® HP-4032D)

(d) 65 g of a xylok curing agent (MEH-78004S),

(e) 0.6 g of an imidazole curing catalyst (2P4 MHZ),

(f) 0.5 g of a mercapto-silane coupling agent (KBM-803) and 0.5 g of a epoxy silane coupling agent (KBM-403), and

(g) 20 g of an amorphous silica filler (AEROSIL® R-972).

### Comparative Example 6

### Fabrication of an Adhesive Film

(a) 100 g of a epoxy group-containing acryl elastomer resin (KLS-1045DR) and 300 g of an epoxy group-containing acryl elastomer (SG-P3TEA),

(b) 60 g of a bisphenol A- and bisphenol F-containing film-forming resin (E4275),

(c) 80 g of a cresol novolac epoxy resin (YDCN-500-1P) and 10 g of a naphthol epoxy resin (EPICLON® HP-4032D),

(d) 65 g of a xylok curing agent (MEH-78004S),

(e) 0.6 g of an imidazole curing catalyst (2P4 MHZ),

(f) 0.5 g of a mercapto-silane coupling agent (KBM-803) and 0.5 g of an epoxy silane coupling agent (KBM-403), and

(g) 20 g of an amorphous silica filler (AEROSIL® R-972).

Evaluation of Material Properties

The material properties of an adhesive film for semiconductor assembly fabricated in Examples 1 to 6 and Comparative Examples 1 to 6 were evaluated as described below, and the results thereof are given in Table 1. Further, in order to determine pick-up success rate, the differences in a 180° peel value between an adhesive layer and a PSA layer and a 180° peel value between an adhesive layer and a wafer, before and after UV irradiation, were calculated. The results of this determination are given in Table 2.

(1) Tensile strength: each film was left at a room temperature (25° C.) for 1 hour, and the tensile strength thereof was then measured using a “dog bone” shaped sample having a size of 20 mm×50 mm and a thickness of 20 μm.

(2) Measurement of 180° peel strength (between an adhesive layer and a PSA layer): in order to measure the adhesion force between the adhesive layer under test and a PSA layer, each film was laminated with a dicing film, left for 1 hour, and then the 180° peel strength therebetween was measured using a rectangular film having a size of 15 mm×70 mm.

The dicing film was fabricated by coating a UV-curable PSA on a polyolefin film having a thickness of 100 μm. Before UV curing, the tack value of the dicing film was 130 gf, and, after UV curing, the tack value of the dicing film was 60 gf. Further, using a sample composed of stainless (SUS 304), before UV curing, the 180° peel value thereof was 0.0055 N/mm, and, after UV curing, the 180° peel value thereof was 0.0010 N/mm.

(3) Measurement of 180° peel strength (between an adhesive layer and a wafer): in order to measure the adhesion force between the adhesive layer under test and a wafer, each film was bonded with a dicing film, left for 1 hour, and was laminated using a wafer having a size of 25 mm×70 mm and a thickness of 720 μm at a temperature of 60° C., a roll pressure of 0.2 MPa and a speed of 20 m/s. The 180° peel strength therebetween was then measured.

The dicing film was fabricated by coating a UV-curable PSA on a polyolefin film having a thickness of 100 μm. Before UV curing, the tack value of the dicing film was 130 gf, and, after UV curing, that of the dicing film was 60 gf. Further, using a sample composed of stainless (SUS 304), before UV curing, the 180° peel value thereof was 0.0055 N/mm, and, after UV curing, the 180° peel value thereof was 0.0010 N/mm.

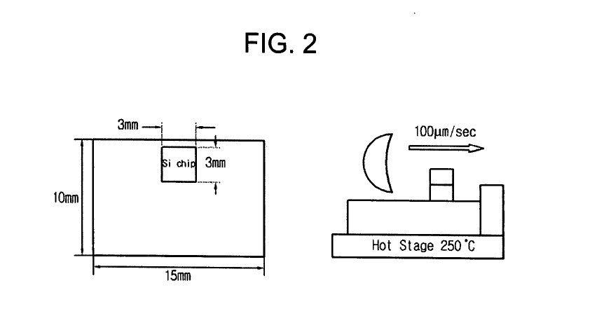

(4) Measurement of die shear strength: a wafer having a thickness of 720 μm was cut to a size of 3 mm×3 mm, as shown in FIG. 2, laminated with an adhesive film at a temperature of 60° C., and then all the wafer laminated with the adhesive was cut except adhered portions. A wafer having a thickness of 720 μm and a size of 10 mm×10 mm was placed on a hot plate having a temperature of 120° C., and a wafer piece laminated with adhesive was attached thereon, and was then pressed by a force of 1 kgf for 20 seconds, and was then completely cured at the conditions of 125° C., 2 hr and 175° C., 2 hr. The die shear strength was measured at a temperature of 250° C. at a speed of 100 μm/sec, as shown in FIG. 2.

TABLE 1

| | | Before UV | After UV | | |
|---|---|---|---|---|---|
| | Tensile | irradiation | irradiation | 180° peel | Die |
| | strength | 180° peel | 180° peel | strength | shear |
| | (kgf/ | strength (a) | strength (b) | (c) | strength |
| | mm²) | (N/mm) | (N/mm) | (N/mm) | (kgf) |
| Example 1 | 1.6 | 0.00313 | 0.00158 | 0.00460 | 15.4 |
| Example 2 | 1.8 | 0.00252 | 0.00192 | 0.00416 | 11.1 |
| Example 3 | 2.0 | 0.00287 | 0.00213 | 0.00394 | 10.5 |
| Example 4 | 1.5 | 0.00314 | 0.00188 | 0.00461 | 17.6 |
| Example 5 | 1.8 | 0.00367 | 0.00222 | 0.00520 | 14.1 |
| Example 6 | 2.3 | 0.00274 | 0.00277 | 0.00384 | 15.8 |
| Comparative | 0.9 | 0.00412 | 0.00264 | 0.00470 | 15.2 |
| Example 1 | | | | | |
| Comparative | 1.0 | 0.00397 | 0.00278 | 0.00440 | 10.8 |
| Example 2 | | | | | |
| Comparative | 1.3 | 0.00410 | 0.00310 | 0.00410 | 10.1 |
| Example 3 | | | | | |
| Comparative | 0.9 | 0.00512 | 0.00298 | 0.00481 | 17.2 |
| Example 4 | | | | | |
| Comparative | 1.1 | 0.00500 | 0.00312 | 0.00530 | 19.9 |
| Example 5 | | | | | |
| Comparative | 1.3 | 0.00367 | 0.00333 | 0.00400 | 15.2 |
| Example 6 | | | | | |

Table 1 notes:
(a): 180° peel strength of adhesive layer/PSA layer before UV irradiation;
(b) 180° peel strength of adhesive layer/PSA layer after UV irradiation;
(c): 180° peel strength of wafer/adhesive layer.

Referring to Table 1, the tensile strength of the adhesive films of Examples 1 to 6, which each contained a pre-curable additive, was increased by about 60% compared to that of the adhesive films of Comparative Examples 1 to 6, which did not contain a pre-curable additive. Further, the 180° peel strength of the adhesive films of Examples 1 to 6 was decreased by about 30% compared to that of the adhesive films of Comparative Examples 1 to 6. Thus, it is apparent that the tensile strength of the adhesive films of Examples 1 to 6 is increased due to the pre-curing of the adhesive film. Further, the die shear strength did not change significantly when the pre-curable additive was added, indicating good processability for Examples 1 to 6.

It will be appreciated that, in order to completely pick up, the adhesion force between a wafer and an adhesive layer should be greater than the adhesion force between an adhesive layer and a PSA layer after UV irradiation. The data for Examples 1 to 6 indicate that, as the difference in the 180° peel strength between the wafer and the adhesive layer and 180° peel strength between the adhesive layer and the PSA layer after UV irradiation is increased, indicating a good pick-up success rate for Examples 1 to 6.

TABLE 2

| | Before UV irradiation | After UV irradiation |
|---|---|---|
| | 180° peel | 180° peel |
| | strength difference | strength difference |
| | (c − a) | (c − b) |
| Example 1 | 0.00147 | 0.00302 |
| Example 2 | 0.00184 | 0.00244 |
| Example 3 | 0.00127 | 0.00201 |
| Example 4 | 0.00147 | 0.00273 |
| Example 5 | 0.00153 | 0.00298 |
| Example 6 | 0.00110 | 0.00107 |
| Comparative Example 1 | 0.00058 | 0.00206 |
| Comparative Example 2 | 0.00043 | 0.00162 |
| Comparative Example 3 | 0 | 0.00100 |
| Comparative Example 4 | 0.00006 | 0.00220 |
| Comparative Example 5 | 0.00030 | 0.00218 |
| Comparative Example 6 | 0.00033 | 0.00067 |

Table 2 notes:
(a): 180° peel strength of adhesive layer/PSA layer before UV irradiation;
(b) 180° peel strength of adhesive layer/PSA layer after UV irradiation;
(c): 180° peel strength of wafer/adhesive layer.

As shown in Table 1, since the 180° peel strength of Examples 1 to 6 is somewhat smaller than that of Comparative Examples 1 to 6, it can be seen that the adhesion force between the wafer and the adhesive layer may decrease slightly. However, as shown in Table 2, it can be seen that, in the difference (c-b) in the 180° peel strength between the wafer and the adhesive layer and 180° peel strength between the adhesive layer and the PSA layer after UV irradiation, which is a measure of pick-up success rate, the difference of Examples 1 to 6 (average value 0.00238) was increased by about 70% compared to that of Comparative Examples 1 to 6 (average value 0.00162). These results mean that pick-up success rate in a semiconductor manufacturing process may be increased using an adhesive layer according to an embodiment.

As described above, an adhesive film composition for semiconductor assembly according to an embodiment may include a pre-curable additive, which may increase the tensile strength of an adhesive film fabricated using the composition. Further, the pick-up success rate in a semiconductor manufacturing process may be increased, thereby realizing an adhesive film for semiconductor assembly that exhibits high reliability and processability. The adhesive film composition may be used to form an adhesive film exhibiting increased tensile strength as compared to a conventional product. An adhesive film prepared according to embodiments may be suitable for a semiconductor process for assembling electronic parts.

Exemplary embodiments have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. An adhesive film composition, comprising:
an elastomer resin having one or more of a hydroxy group, a carboxyl group, or an epoxy group;
a film-forming resin having a glass transition temperature of about −10° C. to about 200° C.;
an epoxy resin;
a phenol-type curing agent;
a curing catalyst;
a pre-curable additive;
a silane coupling agent; and
a filler.

2. The adhesive film composition as claimed in claim 1, further comprising an organic solvent.

3. The adhesive film composition as claimed in claim 1, wherein the composition comprises, based on the weight of the elastomer resin:
about 10 to about 60 parts by weight of the film-forming resin;
about 10 to about 60 parts by weight of the epoxy resin;
about 5 to about 30 parts by weight of the phenol-type curing agent;
about 0.01 to about 5 parts by weight of the curing catalyst;
about 0.01 to about 30 parts by weight of the pre-curable additive;
about 0.01 to about 10 parts by weight of the silane coupling agent; and
about 0.1 to about 60 parts by weight of the filler.

4. The adhesive film composition as claimed in claim 1, wherein the elastomer resin has a weight average molecular weight of about 500 to about 5,000,000.

5. The adhesive film composition as claimed in claim 1, wherein the film-forming resin includes one or more of a phenol resin or a phenoxy resin, has one or more of a hydroxy group, an epoxy group, a phenoxy group or an alkyl group, and has a weight average molecular weight of about 200 to about 300,000.

6. The adhesive film composition as claimed in claim 1, wherein the epoxy resin includes one or more of a bisphenol epoxy resin, a phenol novolac epoxy resin, an ortho-cresol novolac epoxy resin, a multi-functional epoxy resin, an amine epoxy resin, a heterocyclic epoxy resin, a substituted epoxy resin, or a naphthol epoxy resin.

7. The adhesive film composition as claimed in claim 6, wherein the phenol-type curing agent includes one or more of a phenol novolac resin, a xylok resin, a bisphenol A novolac resin, or a cresol novolac resin.

8. The adhesive film composition as claimed in claim 7, wherein the curing catalyst includes one or more of a melamine-type catalyst, an imidazole-type catalyst, or a triphenylphosphine-type catalyst.

9. The adhesive film composition as claimed in claim 1, wherein the pre-curable additive includes an isocyanate.

10. The adhesive film composition as claimed in claim 9, wherein the pre-curable additive includes one or more of the following isocyanates:
4,4′-diphenylmethane diisocyanate, trilene diisocyanate, xylene diisocyanate, 4,4′-diphenylether diisocyanate, 4,4′-[2,2-bis(4-phenoxyphenylpropane)]diisocyanate, hexamethylene diisocyanate, 4,4′-dicyclohexylmethane diisocyanate, 2,4′-dicyclohexylmethane diisocyanate, 2,2,4-trimethyl-hexamethylene diisocyanate, isophorone diisocyanate, lysine diisocyanate, cyclohexylmethane diisocyanate, 1,6-hexamethylene diisocyanate, or a reaction product of diisocyanate or triisocyanate with polyol.

11. The adhesive film composition for semiconductor assembly as claimed in claim 1, wherein the pre-curable additive includes an amine.

12. The adhesive film composition as claimed in claim 11, wherein the pre-curable additive includes one or more of the following amines:
diethylene triamine, triethylene tetramine, diethylaminopropylamine, menthane diamine, N-aminoethyl piperazine, m-xylene diamine, or isophorone diamine.

13. The adhesive film composition as claimed in claim 1, wherein the silane coupling agent includes one or more of an amine-containing silane, an epoxy-containing silane, or a mercapto-containing silane.

14. The adhesive film composition as claimed in claim 13, wherein the filler is a spherical or amorphous inorganic filler containing metal or nonmetal components, and has a size of about 5 nm to about 20 μm.

15. The adhesive film composition as claimed in claim 1, further comprising an ion scavenger, wherein the ion scavenger includes one or more of a triazine-thiol compound, a zirconium compound, an antimony-bismuth compound, or a magnesium-aluminum compound.

16. The adhesive film composition as claimed in claim 15, wherein the composition comprises, based on the weight of the elastomer resin, about 0.01 to about 5 parts by weight of the ion scavenger.

17. A dicing die bonding film, comprising:
a base film;
a first adhesive layer (PSA); and
an adhesive film, the first adhesive layer (PSA) being disposed between the base film and the adhesive film, wherein the adhesive film includes a composition having:
an elastomer resin having one or more of a hydroxy group, a carboxyl group, or an epoxy group;
a film-forming resin having a glass transition temperature of about −10° C. to about 200° C.;
an epoxy resin;
a phenol-type curing agent;
a curing catalyst;
a pre-curable additive;
a silane coupling agent; and
a filler.

18. A semiconductor package, comprising:
a semiconductor device;
an adhesive film; and
a substrate, the adhesive film being disposed between the semiconductor device and the substrate, wherein the adhesive film includes a composition having:
an elastomer resin having one or more of a hydroxy group, a carboxyl group, or an epoxy group;
a film-forming resin having a glass transition temperature of about −10° C. to about 200° C.;
an epoxy resin;
a phenol-type curing agent;
a curing catalyst;
a pre-curable additive;
a silane coupling agent; and
a filler.
